(19) United States
(12) Patent Application Publication
(10) Pub. No.: US 2006/0029350 A1
(43) Pub. Date: Feb. 9, 2006

(54) Integration rod structure for digital projector

(75) Inventors: Chin-Ming Chung, Hsinchu (TW); Pi-Tsung Hsu, Hsinchu (TW); Chien-Chih Lai, Hsinchu (TW); Juin-Hong Lin, Hsinchu (TW)

Correspondence Address: BIRCH STEWART KOLASCH & BIRCH, PO BOX 747, FALLS CHURCH, VA, 22040-0747, US

(73) Assignee: PREMIER IMAGE TECHNOLOGY CORPORATION, Taipei (TW)

(21) Appl. No.: 11/004,855

(22) Filed: Dec. 7, 2004

(30) Foreign Application Priority Data
Aug. 3, 2004 (TW) 093212301

(51) Int. Cl. G02B 6/00

(52) U.S. Cl. 385/133

(57) ABSTRACT

An integration rod structure for a digital projector comprising a length of hollow integration rod and a length of solid integration rod, reflecting an incoming light beam to pass through to acquire a homogeneous light beam in a shorter length than normal solid integration rod with lower energy loss during the refraction. Preferably, the adhesive for bonding the hollow integration rod and the solid integration rod is mixed with small particles (for instance, a plurality of small balls in an average diameter 1 to 1000 μm), to make most of the bonding interfaces not to direct contact to each other, to prevent lower the total reflection effect within the solid integration rod.

### FIELD OF INVENTION

The present invention relates to an integration rod structure for digital projector; more specifically, to an integration rod structure comprising a length of hollow integration rod 1 and a length of solid integration rod combined together.

### BACKGROUND OF THE INVENTION

Digital Light Processing (DLP) is a widely used projection technology. DLP has several advantages, including, high brightness, accurate tone reproduction, a fast response time, noise-free operation, and thin and light composition.

In a DLP projector, a digital control method and a reflection principle are adopted. Light bean from the light source are collected and focused by the lens to pass through an integration rod and a color wheel. The light bean are then projected onto a Digital Micro-mirror Device (DMD). Since the DMD includes several movable micro mirrors, driving electrodes may control the tilt angle and deflection time of each movable mirror. Then, the light bean are projected to form an image by switching the direction of the light ray reflections.

The main function of the integration rod is to homogenize the light beam from the source passing to produce a homogenized light beam. Usually the integration rod can be classified as a hollow integration rod or a solid integration rod. The hollow integration rod is a hollow light channel with an internal surface coated a reflecting film for reflecting incoming light multiple times while the light passing through, and allowing the light emitted from the end of the light channel. While a light beam is reflected inside the integration rod with more times, a more uniform light beam can be emitted from the integration rod. However, the reflective index of the coated reflecting film has its physical limitation, once the length of the hollow integration rod is too long, the more number of times the light is reflected, the more energy loss of the light is resulted, and the illumination of the entire projection system is therefore reduced.

In contrast, the solid integration rod produces the light beam reflection completely inside the optical rod and then emits the light beam. Therefore, the energy of the light beam is not lost due to the influence of the length of the integration rod. However, compared to the hollow integration rod, the incident angle of light beams entering the solid integration rod after refraction at the incident-beam surface is relatively smaller than the number of reflections of the light beams inside the optical rod. Thus, in order to achieve the same degree of uniformity in the projected image as that of the hollow integration rod, the length of the solid integration rod is necessary longer. It usually requires at least one and a half times the length as the hollow integration rod requires.

### SUMMARY OF THE INVENTION

Therefore, to combine both of the advantages from the hollow and solid integration rod, to improve the convention product structure, the main object of the present invention is to provided an new integration rod structure for homogenizing the light beam from source with lower energy loss in a shorter distance.

In order to achieve the above mentioned objects, An integration rod structure is provided, comprising a length of hollow integration rod and a length of solid integration rod, using the length of hollow integration rod to reflect an incident light beam and direct it to pass through the length of solid integration rod to acquire a homogeneous light beam in a shorter length than known solid integration rod with lower energy loss during the refraction light path.

### DESCRIPTION OF THE DRAWINGS

The mentioned objects, various other objects, advantages, and features of the present invention will be more fully understood from the following detailed description of the preferred aspect of the invention when considered in connection with the accompanying drawings below.

FIG. 1 (A) is a cross-sectional view illustrating the first embodiment of the present invention.

FIG. 1 (B) is a perspective view illustrating the first embodiment of the present invention.

FIG. 2 is a cross-sectional view illustrating the light reflection path in the first embodiment of the present invention.

FIG. 3 (A) is a cross-sectional view illustrating the second embodiment of the present invention.

FIG. 3 (B) is a perspective view illustrating the second embodiment of the present invention.

FIG. 4 is a cross-sectional view illustrating the light reflection path in the second embodiment of the present invention.

FIG. 5 (A) is a cross-sectional view illustrating the third embodiment of the present invention.

FIG. 5 (B) is a perspective view illustrating the third embodiment of the present invention.

FIG. 6 is a cross-sectional view illustrating the light reflection path in the third embodiment of the present invention.

### DETAIL DESCRIPTION OF THE PREFERRED EMBODIMENTS

### First Embodiment

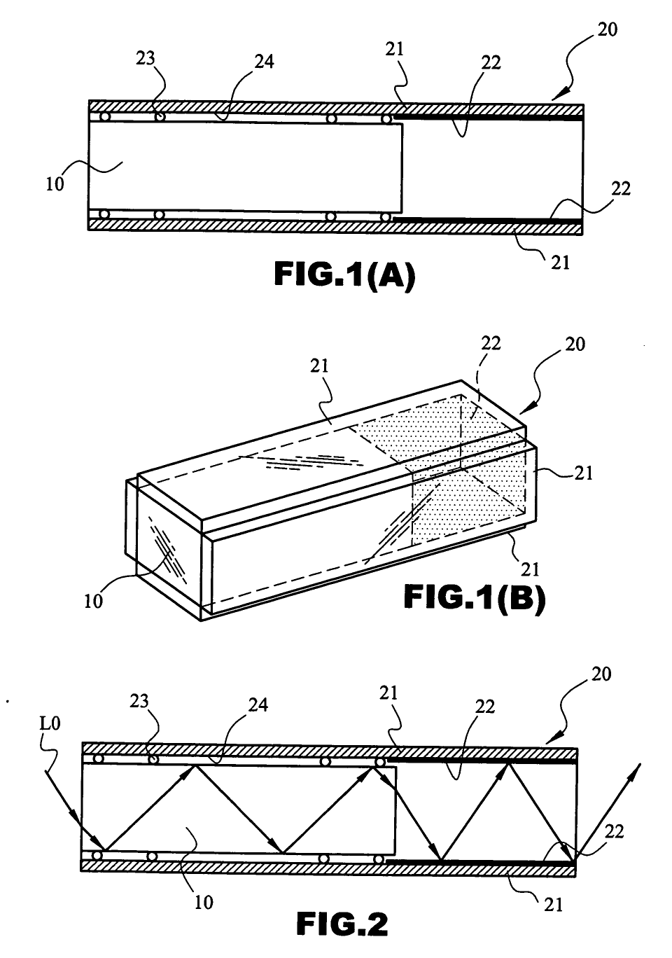

Referring to FIG. 1(A) and FIG. 1(B), an embodiment of integration rod structure in accordance with the present invention, is comprising a length of hollow integration rod (20) bonding with a length of solid integration rod (10), wherein the hollow integration rod (20) is hollow and have a inner surface coating with a reflection layer (22). The reflection layer (22) reflects light multiple times while a light beam is entered and passing through the hollow integration rod (20), then to homogenize light beam. When a light beam from the source is entered such an integration rod, shall be transformed into a homogeneous light beam in a shorter length than normal solid integration rod with lower energy loss. The hollow integration rod (20) is constructed with a set of glass substrate (21) to form a light channel, wherein the glass substrate (21) is coating with a reflection layer (22) at the inner surface for reflecting the incoming light beam. Preferably, the reflection layer (22) may consisted of a mirror-like metallic film or a dielectric film which is deposited or pasted on the glass substrate (21) by a known method.

As we know, the total reflection effect within the solid integration rod (10) is the principle to prevent the energy loss when light reflects and passing through the solid integration rod (10), and transformed a homogenized light beam; Therefore, once the surface of the solid integration rod (10) is touched, clipped or contaminated with dusts, will infect the total reflection effect. Preferably, when bonding the solid integration rod (10) with the hollow integration rod (20), it is suggested to add small particles (23) into the adhesive (24) and mixed it. For instance, the small particles (23) can be a plurality of small balls of 1˜1000 μm in average diameter, to less the contact area between the glass substrate (21) and the surface of solid integration rod (10) after the adhesive (24) solidified.

Referring to FIG. 2, showing the light reflections path passing through the solid integration rod (10) and the hollow integration rod (20). The light beam (L0) is homogenized initially by the solid integration rod (10) and then through the hollow integration rod (20) to provide a further homogenizing effect. It is found in the present embodiment, the structure can effectively prevent the drawback of tradition solid integration rod which is needed longer length about 1.5 times the length of hollow integration rod; meanwhile, it is also can prevent the dust stick on the surface of solid integration rod (10).

### Second Embodiment

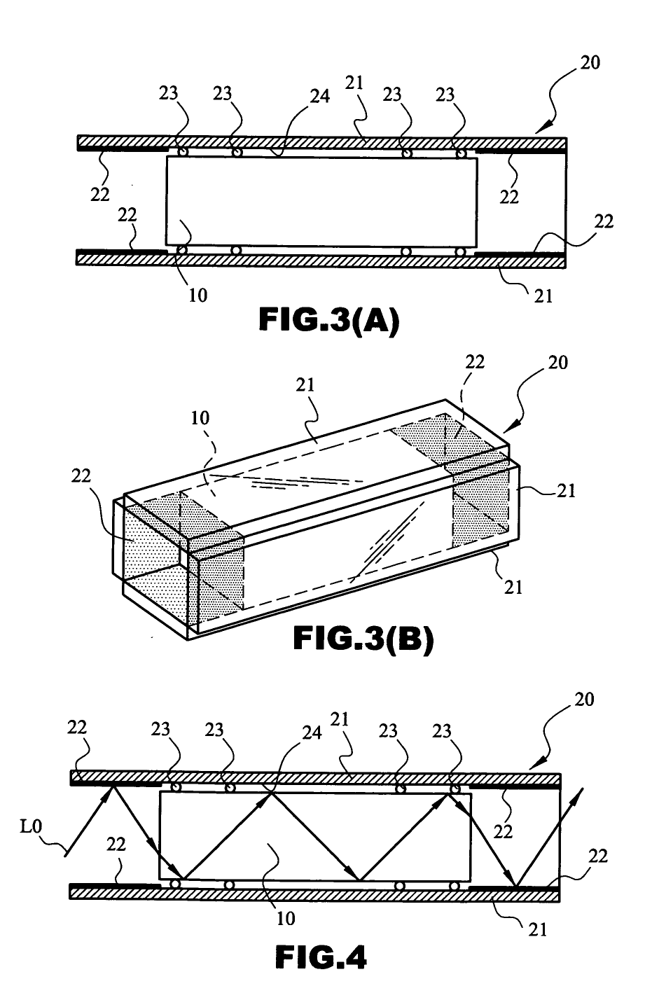

Referring to FIG. 3 (A) and FIG. 3 (B), shown the second embodiment according to the present invention, may comprising a length of solid integration rod (10) bonding with a pair of hollow integration rods (20), wherein the hollow integration rod (20) is longer than the solid integration rod (10) to form the pair of light channel, before entering and after leaving the solid integration rod (10). Therefore, when an incoming light beam (L0) is entered and initially be homogenized by the first end of the hollow integration rod (20), would enter into the solid integration rod (10) for further homogenizing process, and finally, enter the second end of the hollow integration rod (20) for final homogenizing process before leaving the hollow integration rod (20). In the present embodiment, we have found the integration rod can effectively avoid the drawback in conventional solid integration rod which needed longer length; meanwhile, it can also prevent the surface of solid integration rod to be contaminated. Since the light inlet in this structure is a hollow structure, will effectively avoid the high heat accumulation problem while incident light continually focused on the solid structure. Referring FIG. 4, it shows the light path of the light beam (L0) while passes through this mix type integration rod.

### Third Embodiment

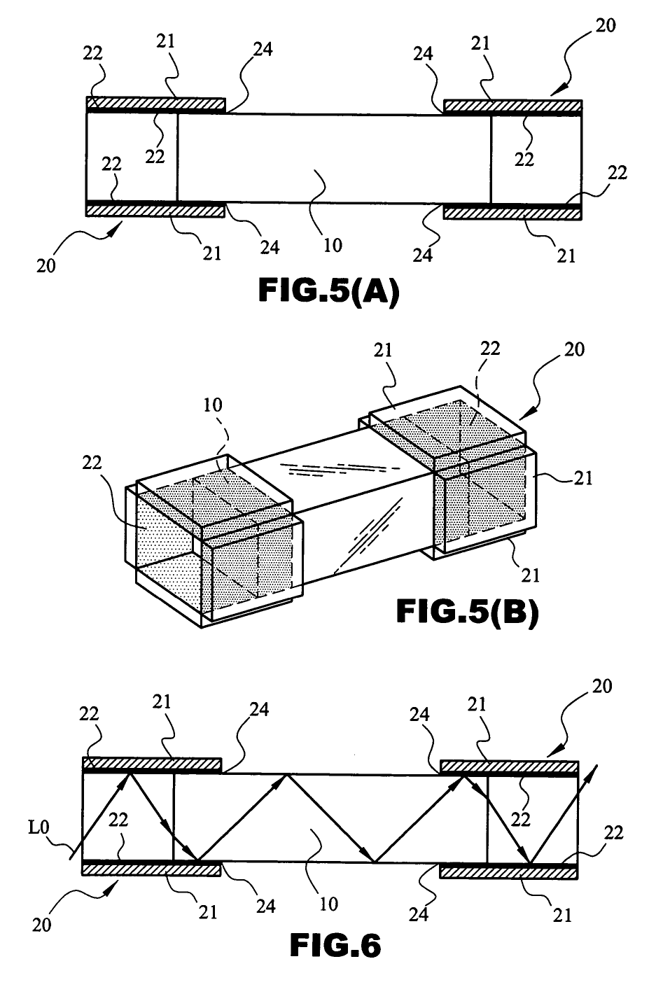

Please further refer to FIG. 5 (A) and FIG. 5 (B). The third embodiment in accordance with the present invention, may comprising a length of solid integration rod (10) and bonding with two lengths of the hollow integration rod (20) both at the ends, to form a pair of light channel before the light beam (L0) enter the solid integration rod (10) and after the light beam (L0) leaving the solid integration rod (10). The solid integration rod (10) and the two lengths of hollow integration rod (20) are bonding by adhesive (24). Although the bonding area may infect the total internal reflection effect within the solid integration rod (10), however, the reflection layer (22) of the glass substrate (21) shall reflect light beam (L0) to compensate the less. Referring FIG. 6, it shows the light path of the light beam (L0) while passes through this mix type integration rod.

This description is intended to provide specific examples of individual embodiments for clearly disclose the present invention. Accordingly, the invention is not limited to these embodiments or to the use of elements having the specific configurations and shapes as presented herein. All alternative modifications and variations of the present invention which fall within the spirit and broad scope of the appended claims are included.

We claim:

1. An integration rod structure for digital camera, comprising
a length of hollow integration rod having an inner surface coated with a reflecting layer for reflecting and homogenizing an incoming light beam; and
a length of solid integration rod connecting to the length of hollow integration rod for reflecting and homogenizing the incoming light beam.

2. The integration rod structure for digital camera in accordance with claim 1, wherein one end of the length of solid integration rod is aligned to one end of the length of hollow integration rod.

3. The integration rod structure for digital camera in accordance with claim 1, wherein the length of solid integration rod is shorter than the length of hollow integration rod and is fixed in between the two ends of the length of hollow integration rods.

4. The integration rod structure for digital camera in accordance with claim 1, wherein the length of solid integration rod is bonding with the length of hollow integration rod by an adhesive.

5. The integration rod structure for digital camera in accordance with claim 1, wherein the length of solid integration rod is bonding with the length of hollow integration rod by an adhesive mixed with a plurality of small particles.

6. The integration rod structure for digital camera in accordance with claim 1, wherein the hollow integration rod is formed as a hollow light channel.

7. The integration rod structure for digital camera in accordance with claim 1, wherein the length of hollow integration rod is consisted of a set of glass substrates coated with a reflection layer for reflecting light.

8. The integration rod structure for digital camera in accordance with claim 7, wherein the reflection layer is a metallic film deposited on the surface of the glass substrate.

9. The integration rod structure for digital camera in accordance with claim 7, wherein the reflection layer is a metallic film pasted on the surface of the glass substrate.

10. The integration rod structure for digital camera in accordance with claim 7, wherein the reflection layer is a dielectric film deposited on the surface of the glass substrate.

11. An integration rod structure for digital camcorder, comprising
a length of solid integration rod for homogenizing an incoming light beam;
a first length of hollow integration rod coated with a reflection layer and connected to the first end of the length of solid integration rod; and
a second length of hollow integration rod coated with a reflection layer and connected to the second end of the length of solid integration rod.

12. The integration rod structure for digital camera in accordance with claim 11, wherein the hollow integration rod is formed as a hollow light channel.

13. The integration rod structure for digital camera in accordance with claim 11, wherein the length of hollow integration rod is consisted of a plurality of glass substrates coated with a reflection layer for reflecting the incoming light beam.

14. The integration rod structure for digital camera in accordance with claim 13, wherein the reflection layer is a metallic film deposited on the surface of the glass substrate.

15. The integration rod structure for digital camera in accordance with claim 13, wherein the reflection layer is a metallic film pasted on the surface of the glass substrate.

16. The integration rod structure for digital camera in accordance with claim 13, wherein the reflection layer is a dielectric film deposited on the surface of a glass substrate.
